(19) United States
(12) Patent Application Publication
(10) Pub. No.: US 2023/0153801 A1
(43) Pub. Date: May 18, 2023

(54) METHOD THAT USES BLOCKCHAIN TECHNOLOGY TO MODERNIZE FUNERAL AND MEMORIAL SERVICE INDUSTRY

(71) Applicant: NICOLAS PLACIDE, Miami, FL (US)

(72) Inventor: NICOLAS PLACIDE, Miami, FL (US)

(21) Appl. No.: 17/528,469

(22) Filed: Nov. 17, 2021

(51) Int. Cl. G06Q 20/38; G06Q 20/06; G06Q 30/06

(52) U.S. Cl. CPC G06Q 20/38215; G06Q 20/065; G06Q 20/3825; G06Q 30/0611

(57) ABSTRACT

A method of using a digital platform that uses blockchain technology and smart contracts to connect end users of funeral and memorial services to body removal services and body storage services. The digital platform will allow body removal services, body storage services, and funeral home service providers to remain compliant with state regulations that are written to govern the funeral and memorial service industries. The method will allow end users to choose a specific funeral package and will allow them payment using a digital token, the digital token will be secured by smart contracts and the packages shall be deployed and memorialized on a blockchain.

### BACKGROUND

The present invention is directed to a method that uses blockchain technology to modernize funeral and memorial service industry.

Saying goodbye to a loved one is never easy. In fact, it’s one of the most challenging things in life, especially in situations when we know that the goodbye is this time final. Many of the strongest emotions that can possibly be experienced by human beings often accompany the loss of a beloved; it can be an overwhelming experience that leave us at our weakest. Complicating matters, those afflicted often make all funeral or memorial services arrangements and they know that there isn’t any time to waste. No matter how much we would like to hold on to the physical presence of a loved one after their death, we simply can’t; decomposition starts settling in almost immediately and, unless the remains are properly handled right away, any hope of an open casket funeral should be forgotten. It is often a very traumatizing experience that can bruise the soul and leave those left behind feeling empty; sometimes for years to come. There is simply no time for comparison shopping. Under those circumstances, it’s certainly understandable that those afflicted by the loss of loved ones don’t always make the best decisions. They usually call the first funeral home that comes to mind, or one which they are familiar with. Often, stricken by grief, they are extremely vulnerable and at a complete disadvantage when facing funeral directors, who are trained professionals, that deal with those type of situations daily. Those professionals know that funerals, or memorial services are usually held to commemorate the lives of those loved. Of course, they know that those making the arrangements for their loved ones want the best they can afford. This is the time when people are at their weakest, and they are often taken advantage of.

While body removal services companies are common, they are not allowed, by law, to offer their services to end-users. They can only remove a body on behalf of a funeral home and either take it to the contracting funeral home or to a licensed storage facility on behalf of that funeral home.

In most states, storage facilities are not permitted to deal with end-users either. They can only store a body on behalf of a funeral home as the body should not spend more than three days in a freezer to minimize swelling if an open casket funeral is desired. That leaves very little time to make preparations.

With the average cost of a funeral varying between $7,000 and $12,000 in the United States, and untimely death can cause a lot of financial stress on top of the emotional stress. That’s a sizable amount of money for most Americans and we can expect for prices to continue to rise not only because of the global situation with Covid-19 but also because of a tremendous increase in the elderly population as people tend to now live longer. A shortage of cemetery space is expected withing a few decades pushing the cost of burials even higher. In cases where the departed didn’t have any life insurance, families often pull their resources together and sometimes take loans.

Institutions offer options for pre-planning funeral expenses to supposedly help alleviate that burden. However, research into the funeral industry practices quickly reveals that most people who use that type of service often end up paying considerably more than those who go the traditional route of making funeral arrangements when needed. This is caused mainly by of a lack of transparency which makes it possible for those institutions to often overcharge their customers.

The present invention is designed to dramatically reduce the financial stress suffered by the aggrieved whom have lost a loved one, by giving them transparency when arranging for the funeral and memorial services of their loved ones.

The present invention leverages blockchain, smart contracts, and decentralized finance to solve the current issues around funeral and memorial services and aims to prevent problems that negatively affect the funeral industry. The present invention creates a global funeral care platform that uses blockchain technology to connect industry players to end-users, thereby removing entry barriers, and eliminating most middlemen in the funeral and memorial service industry whose only contribution is to increase the cost of the services.

### SUMMARY

The present invention is a method of using a digital platform that uses blockchain technology and smart contracts to connect end users of funeral and memorial services to body removal services and body storage services. The digital platform will allow body removal services, body storage services, and funeral home service providers to remain compliant with state regulations that are written to govern the funeral and memorial service industries.

The present invention uses a dedicated website and a mobile application that has an interface that is configured to be used by end users and memorial service providers. End users will be able to either look for existing services listed by any funeral or memorial service provider, for they will be able to create their own funeral service request. The present invention will allow end users to choose a specific funeral package and will allow them payment using a digital token, the digital token will be secured by smart contracts and the packages shall be deployed and memorialized on a blockchain.

End users who need customized funeral services will be able to get their loved ones removed using the digital platform. The digital platform will allow the end users to select the funeral options/services they select, for example, burial or cremation services, casket, limousine, cemetery location, crypt vault, hotel, travel, car rental, etc. Funeral options/services selected by the end user will be sent to all the funeral homes in the area selected by the user, and each funeral service provider will be able to reply with their prices, additional terms, options, etc. Any offer sent by any funeral service provider will be recorded in the blockchain and can be viewed by the end user or the deceased’s family, thus enticing fair competition and eliminating the role of price manipulation by any funeral service provider or of a single-player monopoly. The digital token of the present invention will allow end users to receive discounted payments and will guarantee memorial service providers with future payments, for the only guarantee in life is that eventually we will all move on.

The present invention digital platform uses blockchain (a distributed ledger) and smart contracts to ensure that all transactions between transacting parties are trustless, transparent, on-chain, and secured. Each offeror, each transactional activity within the platform, is recorded in the blockchain and can be viewed by the deceased’s family either through an application or through a publicly available explorer. Should a case have to go to court because of a he says/she says situation, there will be a clear paper trail to protect both parties with a clear indication of what was contractually agreed upon. The digital platform uses a digital token/coin, that enables users to pay for the services at discounted rates while possibly enjoying additional benefits.

The digital platform of the present invention uses a user interface that will allow end users and funeral and memorial service providers to connect to each other using the digital platform as further defined below.

End users will be provided with a user interface that will allow them to arrange a funeral. The user interface will allow the end users to see a list of available funeral and memorial service providers and the available packages that each funeral and memorial service provider offers and any reviews that made with respect to each funeral and memorial service provider. The interface shall allow end users to purchase a package from any of the funeral and memorial service providers. The interface will also allow end users to request custom quotes for services they require. The interface shall also allow the end users to pay for the funeral and memorial services using the digital tokens or any other payment method. The method of the present invention shall convert any payment made using the digital platform to a digital token and the providers of the funeral or memorial services shall have the option to be paid by the digital tokens or by fiat money.

Funeral or memorial service providers will be provided with an interface that will allow them access to a dashboard. The dashboard will allow them to list their services alongside details of their offering and the pricing. The dashboard will also allow the service providers with the costs associates with the services they are providing to end users. The dashboard will allow the service providers to: receive orders from end users; to arrange for collateral contracts with other product or other service providers; to receive customized orders from end users; to bid on customized orders; to directly communicate with end users; to send smart contracts to end users; and to upload requests for payments from the digital platform after completion of any smart contract on the digital platform.

An object of the present invention is to reduce the production costs involved in the funeral industry.

Another object of the present invention is to allow grieving end users transparency when they arrange for funeral services for their loved ones.

Yet another object of the present invention is to improve the quality of services provided by funeral and memorial service providers to end users, for the transparency of each memorial service provided will help guide end users of the digital platform of a record of each funeral and memorial service provider.

Yet still another object of the present invention is to allow end users to pay for future memorial services with a digital token and to allow funeral and memorial service providers the ability to accept the digital coin when the smart contract for which the digital coin was negotiated is completed by the funeral or memorial service provider.

### DRAWINGS

These and other features, aspects, and advantages of the present invention will become better understood with regards to the following description, appended claims, and drawings where:

FIG. 1 is a Flowchart that shows the platform operation of the present invention;

FIG. 2 is the first part of Flowchart that shows the creation of a transaction;

FIG. 3 is the second part of the Flowchart that shows the creation of the transaction; and

FIG. 4 is a Flowchart that shows a negotiated contract of the present invention.

### DESCRIPTION

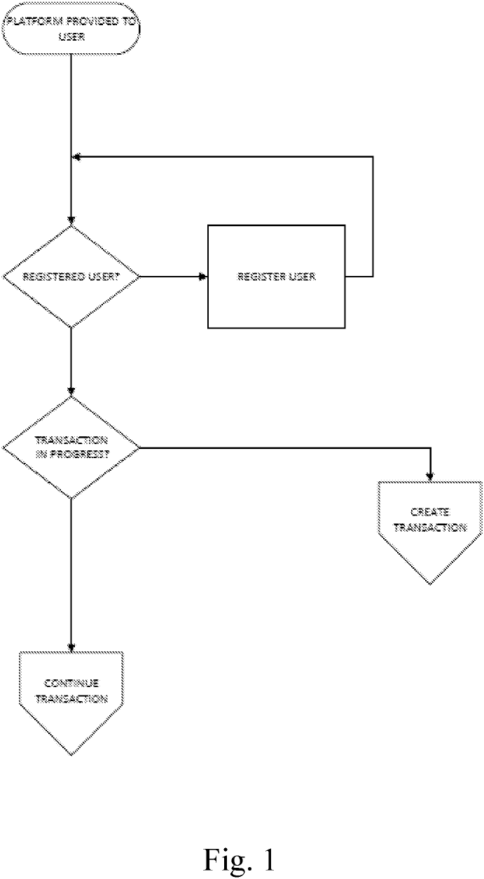

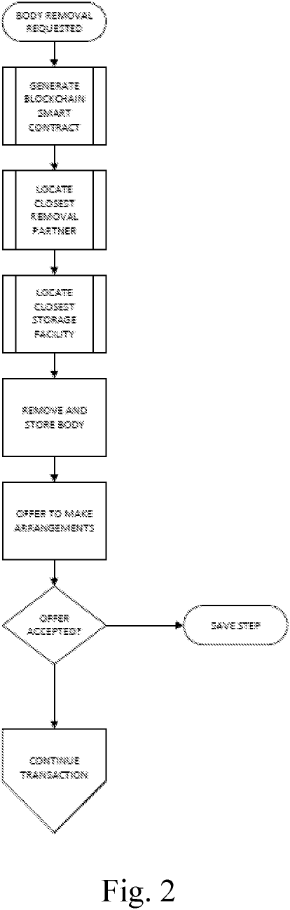

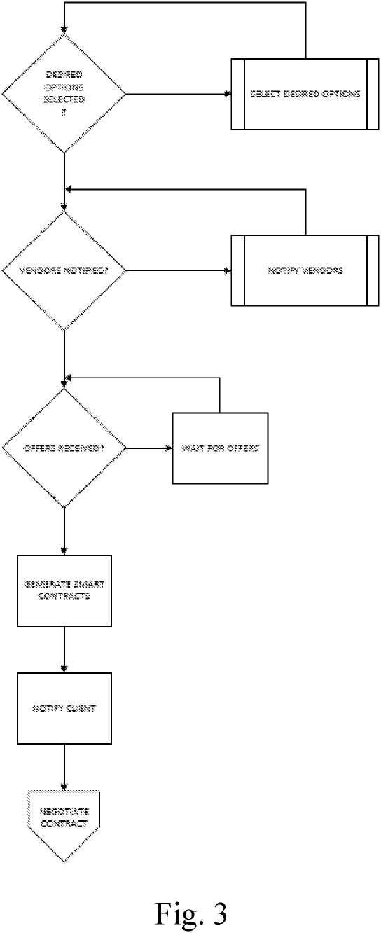

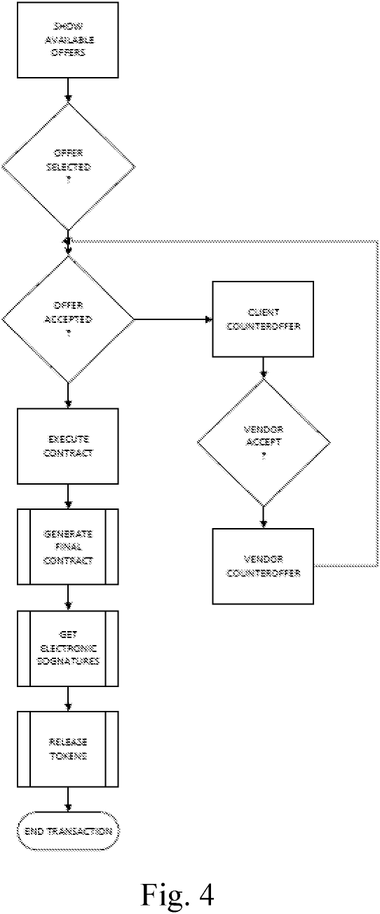

As seen in FIGS. 1-4, the present invention is a method that uses blockchain technology to modernize funeral and memorial service industry.

The method comprising providing an online gateway that is configured to allow any end user and any funeral or memorial service provider to communicate with each other using a digital platform. Providing the digital platform, the digital platform is configured to: allow the any end user the ability to arrange for a funeral arrangement; allow the any funeral or memorial service provider to list any good or service that the any funeral or memorial service provider offers to the public; provide a digital coin that can be purchased by the any end user to purchase the any funeral or memorial service from the any funeral or memorial service provider; provide a smart contract that can be used between the any end user and the any funeral or memorial service provider; memorialize the smart contact on a distributed ledger; provide a set of rules related to the digital coin purchased; provide the any funeral and memorial service provider with the ability to inform the digital platform that the any funeral or memorial service has been performed and request for payment; allow the digital platform to confirm the smart contract has been completed by the any funeral or memorial service; and allow that digital platform to pay the any funeral or memorial service in accordance to the set of rules. Providing an end user digital interface that is configured to allow the any end user to arrange a funeral arrangement, to purchase the funeral arrangement, to purchase a digital coin, to request a custom quote for funeral home arrangement, to enter into a smart contract that can be saved on a distributed ledger for the funeral arrangement. And, providing a funeral or memorial service interface that is configured to allow the any funeral or memorial service provider with access to a dashboard that will allow the any funeral or memorial service provider to offer any product or service to the any end user, to enter into a smart contract with the any end user purchasing any product or service, to bid on any custom quote received from the any end user, to receive payment for any product or service provided to the any end user.

In preferred embodiments, any payment made by the digital platform to the any funeral or memorial service provider is first made using the digital coin and then allowing the any funeral or memorial service provider to request a conversion of the digital coin to fiat money, and lastly having the digital platform pay the any funeral or memorial service provider with the fiat money.

In preferred embodiments, the digital platform will allow any third party to purchase the digital coin.

In preferred embodiments, the digital platform provides the any third party with an internet explorer to research any smart contracts memorialized on the distributed ledger.

An advantage of the present invention is that it reduces the production costs involved in the funeral industry.

Another advantage of the present invention is that it allows grieving end users transparency when they arrange for funeral services for their loved ones.

Yet another advantage of the present invention is that it improves the quality of services provided by funeral and memorial service providers to end users, for the transparency of each memorial service provided will help guide end users of the digital platform of a record of each funeral and memorial service provider.

Yet still another advantage of the present invention is that it allows end users to pay for future memorial services with a digital token and to allow funeral and memorial service providers the ability to accept the digital coin when the smart contract for which the digital coin was negotiated is completed by the funeral or memorial service provider.

The embodiments of the method that uses blockchain technology to modernize funeral and memorial service industry described herein are exemplary and numerous modifications, combinations, variations, and rearrangements can be readily envisioned to achieve an equivalent result, all of which are intended to be embraced within the scope of the appended claims. Further, nothing in the above-provided discussions of the method that uses blockchain technology to modernize funeral and memorial service industry should be construed as limiting the invention to an embodiment or a combination of embodiments. The scope of the invention is defined by the description, drawings, and appended claims.

What is claimed is:

1. A method that uses blockchain technology to modernize funeral and memorial service industry, the method comprising:
providing an online gateway that is configured to allow any end user and any funeral or memorial service provider to communicate with each other using a digital platform;
providing the digital platform, the digital platform is configured to:
allow the any end user the ability to arrange for a funeral arrangement;
allow the any funeral or memorial service provider to list any good or service that the any funeral or memorial service provider offers to the public;
provide a digital coin that can be purchased by the any end user to purchase the any funeral or memorial service from the any funeral or memorial service provider;
provide a smart contract that can be used between the any end user and the any funeral or memorial service provider;
memorialize the smart contact on a distributed ledger;
provide a set of rules related to the digital coin purchased;
provide the any funeral and memorial service provider with the ability to inform the digital platform that the any funeral or memorial service has been performed and request for payment;
allow the digital platform to confirm the smart contract has been completed by the any funeral or memorial service; and
allow that digital platform to pay the any funeral or memorial service in accordance to the set of rules;
providing an end user digital interface that is configured to allow the any end user to arrange a funeral arrangement, to purchase the funeral arrangement, to purchase a digital coin, to request a custom quote for funeral home arrangement, to enter into a smart contract that can be saved on a distributed ledger for the funeral arrangement; and
providing a funeral or memorial service interface that is configured to allow the any funeral or memorial service provider with access to a dashboard that will allow the any funeral or memorial service provider to offer any product or service to the any end user, to enter into a smart contract with the any end user purchasing any product or service, to bid on any custom quote received from the any end user, to receive payment for any product or service provided to the any end user.

2. The method that uses blockchain technology to modernize funeral and memorial service industry of claim 1, wherein any payment made by the digital platform to the any funeral or memorial service provider is first made using the digital coin and then allowing the any funeral or memorial service provider to request a conversion of the digital coin to fiat money, and lastly having the digital platform pay the any funeral or memorial service provider with the fiat money.

3. The method that uses blockchain technology to modernize funeral and memorial service industry of claim 2, wherein the digital platform allows any third party to purchase the digital coin.

4. The method that uses blockchain technology to modernize funeral and memorial service industry of claim 3, wherein the digital platform provides the any third party with an internet explorer to research any smart contracts memorialized on the distributed ledger.
